(19) United States
(12) Patent Application Publication
(10) Pub. No.: US 2007/0109936 A1
(43) Pub. Date: May 17, 2007

(54) Optical disc servo that is robust for defects

(76) Inventors: Hendrik Josephus Goossens, Shanghai (CN); Peter Fogh Odgaard, Aalborg East (DK)

Correspondence Address: PHILIPS INTELLECTUAL PROPERTY & STANDARDS, P.O. BOX 3001, BRIARCLIFF MANOR, NY, 10510, US

(21) Appl. No.: 10/581,640

(22) PCT Filed: Nov. 30, 2004
(86) PCT No.: PCT/IB04/52606

§ 371 Date: Jun. 5, 2006

(30) Foreign Application Priority Data
Dec. 8, 2003 (EP) 03104587.5

(51) Int. Cl. G11B 7/00; G11B 20/18

(52) U.S. Cl. 369/53.33; 369/53.35

(57) ABSTRACT

A method is described for discriminating different types of disc defects in an optical disc drive apparatus (1) of a type comprising: scanning means (30) for scanning a record track of an optical disc (2) and for generating a read signal (S_{R}), the scanning means (30) comprising at least one displaceable read/write element (34); actuator means (50) for controlling the positioning of said read/write element; a control circuit (90) for generating at least one actuator control signal (S_{CR}, S_{CF}, S_{CT}) on the basis of at least one signal component (REN, FEN) of said read signal, the control circuit having a plurality of predetermined controller settings; the method comprising the steps of: deriving from said read signal at least one signal component (MIRN ; performing a frequency analysis of said signal component; selectively setting one of said plurality of predetermined controller settings on the basis of the results of said frequency analysis.

### FIELD OF THE INVENTION

The present invention relates in general to an optical disc drive apparatus for writing/reading information into/from an optical storage disc.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writeable type, where information may be stored by a user. For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), an objective lens for focussing the light beam in a focal spot on the disc, and an optical detector for receiving the reflected light reflected from the disc and for generating an electrical detector output signal. The optical detector comprises multiple detector segments, each segment providing an individual segment output signal.

During operation, the light beam should remain focussed on the disc. To this end, the objective lens is arranged axially displaceable, and the optical disc drive comprises focal actuator means for controlling the axial position of the objective lens. Further, the focal spot should remain aligned with a track or should be capable of being positioned with respect to a new track. To this end, at least the objective lens is mounted radially displaceable, and the optical disc drive comprises radial actuator means for controlling the radial position of the objective lens.

In many disc drives, the objective lens is arranged tiltably, and such optical disc drive comprises tilt actuator means for controlling the tilt angle of the objective lens.

For controlling these actuators, the optical disc drive comprises a controller, which receives an output signal from the optical detector. From this signal, hereinafter also referred to as read signal, the controller derives one or more error signals, such as for instance a focus error signal, a radial error signal, and, on the basis of these error signals, the controller generates actuator control signals for controlling the actuators such as to reduce or eliminate position errors.

In the process of generating actuator control signals, the controller shows a certain control characteristic. Such control characteristic is a feature of the controller, which may be described as the way in which the controller behaves as reaction to detecting position errors.

A disc may contain disc defects, which may disturb the read-out of the disc because these defects cause erroneous error signals. The two most important classes of disc defects are:

1) short defects like dust and scratches

2) long defects like fingerprints.

A prior art solution to this problem involves a defect detector which monitors the normalized mirror signal (MIRN), and which switches off the error signals if it detects an error situation, so that the controller output signal is held at a constant level. As soon as the defect detector detects that the defect has passed, it switches on the error signals again. As it were, the optical pickup “flies blind” over the defect.

This solution works reasonably well as far as detecting the start of small errors is concerned. However, this solution also has several problems.

A first problem is that the end of the defect is not always detected reliably. As a result, the error signals may be switched back on too late, so that a large position error may develop, or the error signals may be switched back on too early, when the error signals still contain errors.

A second problem is that fingerprints are not detected well. As a result, the defect is not detected well, so that a large position error may develop. Moreover, it may be that the error signals are switched on and off many times during the passage of the fingerprint, which causes many discontinuities in the controller input signal and therefore bad tracking behaviour and bad focusing behaviour.

A further problem in respect of fingerprints is that it is not possible to switch off the error signals during the entire passage of a fingerprint, since then the optical pickup will tend to drift away from its optimal position and a large position error may develop.

A basic problem in this respect is that adequately handling small defects actually requires a different control characteristic than adequately handling large defects. Conventionally, the controller of a disc drive has a fixed control characteristic, which may be specifically adapted for adequately handling small defects (in which case error control is not optimal in the case of large defects) or specifically adapted for adequately handling large defects (in which case error control is not optimal in the case of small defects), or the control characteristic is a compromise (in which case error control is not optimal in the case of large defects as well as in the case of small defects).

In the state of the art, it has already been proposed to change the gain of the controller, depending on the type of disturbance experienced. For instance, reference is made to U.S. Pat. No. 4.722.079.

In order to be able to implement a controller having variable gain, it is necessary to determine which class of defect is at hand. Said U.S. Pat. No. 4.722.079 describes a system where an optical read signal is processed to determine disturbance class, but this system requires a 3-beam optical system.

U.S. Pat. No. 5.867.461 also describes a system where an optical read signal is processed to determine disturbance class. In this known system, the envelope is determined of the high frequency signal contents. One disadvantage of this method is that it relies on data written on the disc; it is not applicable in the case of blank discs. Another disadvantage is that this method requires complicated circuitry, inter alia for detecting upper peaks and lower peaks, for filtering in order to detect upper envelope and lower envelope, for analysing these envelopes, and for storing signals in a memory.

A general problem relates to adapting the control characteristics in a disc drive which should be capable of small disc defects as well as large disc defects. Changing the control characteristics such that one type of disc defect is handled better may seriously affect the controller's capability to handle a disc defect of another type.

A general objective of the present invention is to provide a method for determining more reliably whether an event corresponds to the occurrence of a small defect or a large disc defect.

Further, it is an objective of the present invention to provide a method for changing control characteristics of the controller on the basis of the results of the above-mentioned determinations.

Further, it is an objective of the present invention to provide a disc drive apparatus having a servo system with improved robustness in the case of disc defects.

### SUMMARY OF THE INVENTION

According to a first important aspect of the present invention, a defect detector is designed to operate on the basis of time-frequency analysis of the signal to be monitored. The frequency-content of a small time-interval of the incoming signal is determined and analyzed; a decision on whether a defect occurs, and whether the defect is a small or a large defect, is made on the basis of this frequency-content. In a preferred embodiment, discrete wavelet analysis is used.

According to a second important aspect of the present invention, a control circuit comprises a plurality of controllers, each having its own setting specifically chosen for a specific class of defects. Based on the decision made by the defect detector, one of the controllers is selectively switched on while all others are switched off. Alternatively, one controller with selectable settings is used.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A schematically illustrates relevant components of an optical disc drive apparatus;

FIG. 1B schematically illustrates an embodiment of an optical detector in more detail;

FIG. 2 is a block diagram schematically illustrating a control circuit according to a first embodiment of the invention in more detail;

FIG. 3 is a block diagram schematically illustrating a control circuit according to a second embodiment of the invention in more detail;

FIG. 4 is a block diagram schematically illustrating discrete wavelet analysis;

FIGS. 5-7 are graphs schematically illustrating the result of discrete wavelet analysis.

### DESCRIPTION OF THE INVENTION

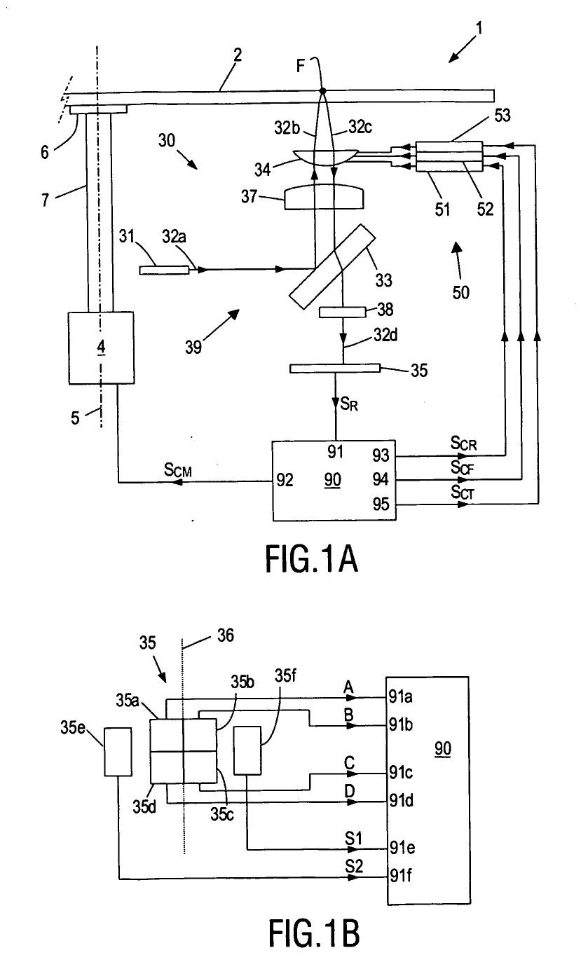

FIG. 1A schematically illustrates an optical disc drive apparatus 1, suitable for storing information on or reading information from an optical disc 2, typically a DVD or a CD.

For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1A, the optical system 30 comprises a light beam generating means 31, typically a laser such as a laser diode, arranged to generate a light beam 32. In the following, different sections of the light beam 32, following an optical path 39, will be indicated by a character a, b, c, etc. added to the reference numeral 32.

The light beam 32 passes a beam splitter 33, a collimator lens 37 and an objective lens 34 to reach (beam 32b) the disc 2. The objective lens 34 is designed to focus the light beam 32b in a focal spot F on a recording layer (not shown for sake of simplicity) of the disc. The light beam 32b reflects from the disc 2 (reflected light beam 32c) and passes the objective lens 34, the collimator lens 37, and the beam splitter 33, to reach (beam 32d) an optical detector 35. In the case illustrated, an optical element 38 such as for instance a prism is interposed between the beam splitter 33 and the optical detector 35.

The disc drive apparatus I further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since focal actuators are known per se, while further the design and operation of such focal actuator is no subject of the present invention, it is not necessary here to discuss the design and operation of such focal actuator in great detail.

For achieving and maintaining a correct tilt position of the objective lens 34, the objective lens 34 may be mounted pivotably; in such case, as shown, the actuator system 50 also comprises a tilt actuator 53 arranged for pivoting the objective lens 34 with respect to the disc 2. Since tilt actuators are known per se, while further the design and operation of such tilt actuator is no subject of the present invention, it is not necessary here to discuss the design and operation of such tilt actuator in great detail.

It is further noted that means for supporting the objective lens with respect to an apparatus frame, and means for axially and radially displacing the objective lens, as well as means for pivoting the objective lens, are generally known per se. Since the design and operation of such supporting and displacing means are no subject of the present invention, it is not necessary here to discuss their design and operation in great detail.

It is further noted that the radial actuator 51, the focal actuator 52 and the tilt actuator 53 may be implemented as one integrated actuator.

The disc drive apparatus I further comprises a control circuit 90 having a first output 92 connected to a control input of the motor 4, having a second output 93 coupled to a control input of the radial actuator 51, having a third output 94 coupled to a control input of the focal actuator 52, and having a fourth output 95 coupled to a control input of the tilt actuator 53. The control circuit 90 is designed to generate at its first output 92 a control signal S_{CM} for controlling the motor 4, to generate at its second control output 93 a control signal S_{CR} for controlling the radial actuator 51, to generate at its third output 94 a control signal S_{CF} for controlling the focal actuator 52, and to generate at its fourth output 95 a control signal S_{CT} for controlling the tilt actuator 53.

The control circuit 90 further has a read signal input 91 for receiving a read signal S_{R} from the optical detector 35.

FIG. 1B illustrates that the optical detector 35 may comprise a plurality of detector segments. In the case illustrated in FIG. 1B, the optical detector 35 comprises six detector segments 35a, 35b, 35c, 35d, 35e, 35f, capable of providing individual detector signals A, B, C, D, S1, S2, respectively, indicating the amount of light incident on each of the six detector segments, respectively. Four detector segments 35a, 35b, 35c, 35d, also indicated as central aperture detector segments, are arranged in a four-quadrant configuration. A centre line 36, separating the first and fourth segments 35a and 35d from the second and third segments 35b and 35c, has a direction corresponding to the track direction. Two detector segments 35e, 35f, also indicated as satellite detector segments, and which may themselves be subdivided into subsegments, are arranged symmetrically besides the central detector quadrant, on opposite sides of said centre line 36. Since such six-segment detector is commonly known per se, it is not necessary here to give a more detailed description of its design and functioning.

It is noted that different designs for the optical detector 35 are also possible. For instance, the satellite segments may be omitted, as known per se.

FIG. 1B also illustrates that the read signal input 91 of the control circuit 90 actually comprises a plurality of inputs for receiving all individual detector signals. Thus, in the illustrated case of a six-quadrant detector, the read signal input 91 of the control circuit 90 actually comprises six inputs 91a, 91b, 91c, 91d, 91e, 91f for receiving said individual detector signals A, B, C, D, S1, S2, respectively. As will be clear to a person skilled in the art, the control circuit 90 is designed to process said individual detector signals A, B, C, D, S1, S2, in order to derive data signals and one or more error signals. A radial error signal, designated hereinafter simply as RE, indicates the radial distance between a track and the focal spot F. A focus error signal, designated hereinafter simply as FE, indicates the axial distance between a storage layer and the focal spot F. It is noted that, depending on the design of the optical detector, different formulas for error signal calculation may be used. Generally speaking, such error signals each are a measure for a certain kind of asymmetry of the central optical spot on the detector 35, and hence are sensitive to displacement of the optical scanning spot with respect to the disc.

A special signal which can be derived by processing said individual detector signals is the mirror signal MIRN, obtained by a weighed summation of all individual detector signals A, B, C, D, S1, S2 according to
MIRN=A+B+C+D+W(S1+S2) (1)
wherein W indicates a weighing factor, typically in the order of about 15. This signal is a measure for the reflectivity of the disc.

Also, the usual error signals, such as REN, may be derived, as will be known to persons skilled in the art. By way of example, a radial error signal REN can be defined according to

$$REN = \frac{( A + D ) - ( B + C ) - W ( S 1 - S 2 )}{A + B + C + D + S 1 + S 2} \qquad ( 2 )$$

W being a weighing factor.

The control circuit 90 is designed to generate its control signals as a function of the error signals, to reduce the corresponding error, as will be clear to a person skilled in the art. For instance, the control circuit 90 may generate its radial control signal S_{CR} on the basis of the radial error signal REN. In the following, the present invention is explained specifically for the radial control, without this being intended as limiting the invention.

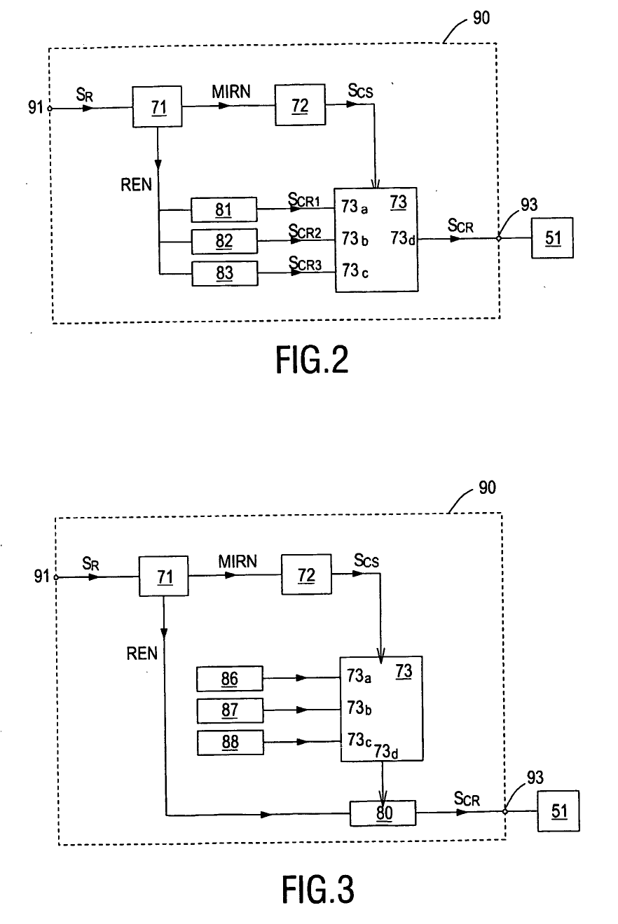

FIG. 2 is a block diagram schematically illustrating a part of an exemplary control circuit 90 in more detail. For the sake of discussion, this part of control circuit 90 may relate to the control of the radial actuator 51.

The control circuit 90 comprises a signal processor 71, having its input coupled to the first input 91 of the control circuit 90, for processing the read signal S_{R}, and for deriving the normalized mirror signal MIRN as well as an error signal REN.

The control circuit 90 further comprises a plurality of controllers 81, 82, 83, which each have an input receiving the error signal REN. Each controller is designed to generate an actuator control signal S_{CR1}, S_{CR2}, S_{CR3}, respectively, suitable for being supplied to the radial controller 51.

In the illustrative example, the control circuit 90 comprises three controllers 81, 82, 83, having optimized settings for use in specific situations. A first controller 81 is specifically designed for use in normal situations, without disc effects occurring. A second controller 82 is specifically designed for use in the case of short disc defects like dust and scratches. A third controller 83 is specifically designed for use in the case of long disc defects like fingerprints. However, it should be clear that the control circuit 90 may comprise four or more specialized controllers, or only two.

The control circuit 90 further comprises a controllable switch 73 having three inputs 73a, 73b, 73c coupled to outputs of the controllers 81, 82, 83, respectively, and having an output 73d coupled to the output 93 of the control circuit 90. The switch 73 has three operative states: in a first operative state, the output 73d is coupled to the first input 73a; in a second operative state, the output 73d is coupled to the second input 73b; in a third operative state, the output 73d is coupled to the third input 73c.

The control circuit 90 further comprises a signal analyser 72, having an input receiving the signal MIRN from the signal processor 71, and having an output for generating a control signal S_{CS} for controlling the controllable switch 73. Thus, depending on the control signal S_{CS} from the analyser 72, the actuator 51 is controlled by a control signal generated by one of the specialized controllers 81, 82, 83.

FIG. 3 is a block diagram schematically illustrating an alternative embodiment of the control circuit 90. Instead of three controllers, this embodiment of the control circuit comprises only one controller 80, having an input receiving the radial error signal REN, and having an output coupled to the output 93 of the control circuit 90. The controller 80 has selectable settings, which are set on the basis of the output signal S_{CS} from the analyser 72. It may be that the controller 80 itself is controlled directly by the output signal S_{CS} from the analyser 72. In the embodiment illustrated, the setting of the controller 80 is determined by external setting units 86, 87, 88, each unit providing settings specifically designed for normal situations, short disc defects, and long disc defects, respectively. Controllable switch 73 has its output 73d coupled to a control input of the controller 80, and has its three inputs 7a, 73b, 73c coupled to the outputs of the setting units 86, 87, 88, respectively. Thus, the setting of the controller 80 is determined by the control signal S_{CS} from the analyser 72.

Thus, in both embodiments, the actuator 51 is controlled by a controller having a setting specifically adapted to actual operative conditions “normal”, “short disc defect”, “long disc defect”.

It should be clear to a person skilled in the art that the illustrative examples have three selectable settings, but the number of specialized settings may, in the context of the present invention, be two, or four or more.

The analyser 72 is adapted to analyse the normalised mirror signal MIRN to determine which control signal to output, i.e. to determine whether the signal MIRN indicates a normal situation, or the occurrence of a long or short defect. Specifically, the analyser 72 is adapted to assess the frequency contents of the MIRN signal. More specifically, the analyser 72 is adapted to divide the MIRN signal into multiple frequency ranges, and to make a decision on the basis of the information contents in the different frequency ranges. According to a preferred aspect of the present invention, the analyser 72 performs a time-frequency analysis of the MIRN signal.

Time-frequency analysis of a signal is a well-known technique. It involves determining the frequency content of the signal under investigation during a predetermined small time interval. One example of time-frequency analysis is discrete wavelet analysis, a method which will briefly be explained in the following. For a more detailed information, reference is made to, for instance, U.S. Pat. No. 5,815,198. It is noted that time-frequency analysis can be performed in a different manner; for instance, Short Time Fourier Transformation (STFT) is also a possibility. However, wavelet analysis is preferred, since this method has better time resolution properties.

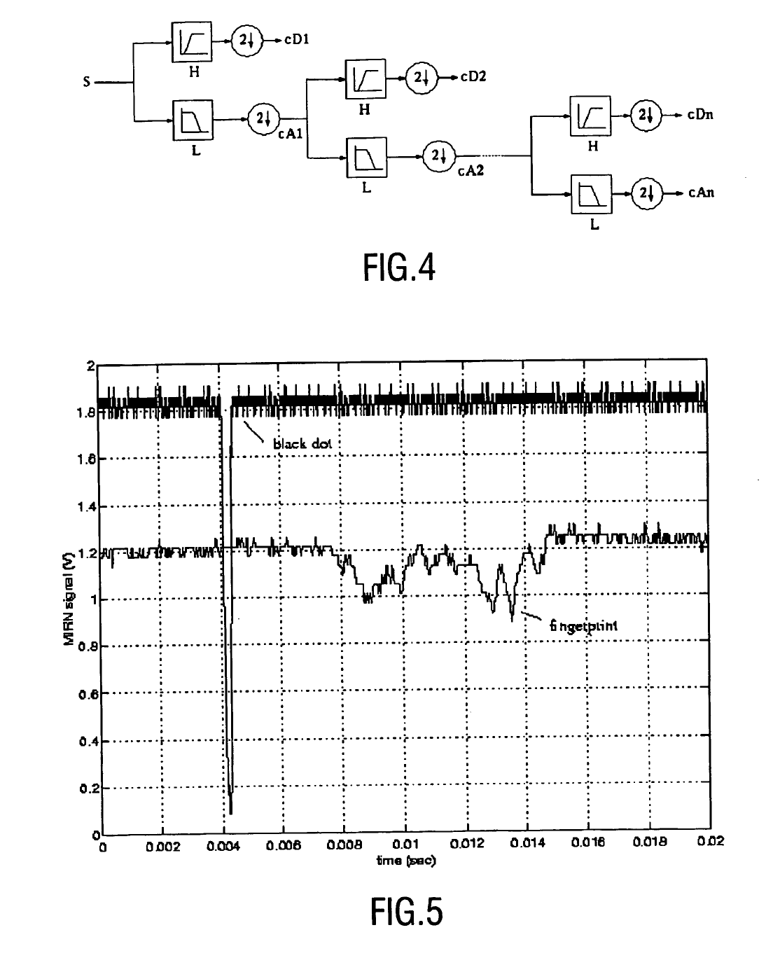

FIG. 4 is a block diagram schematically illustrating discrete wavelet analysis of a sampled signal S. In a first stage 110, the signal S is fed to a first digital high pass filter 111 and a first digital low pass filter 112. The sampling frequencies of the results are divided by two, as indicated by an operation 21, to remove redundant information. The resulting samples from the first digital high pass filter 111 are termed “detail coefficients at scale 1”, and are indicated as cD1. The resulting samples from the first digital low pass filter 112 are termed “approximation coefficients at scale 1”, and are indicated as cA1. The detail coefficients at scale 1 (cD1) represent the highest frequencies in the signal S.

In a second stage 120, the approximation coefficients at scale 1 (cA1) are fed to a second digital high pass filter 121 and a second digital low pass filter 122. Again, the sampling frequencies of the results are divided by two (2↓). The resulting samples from the second digital high pass filter 121 are termed “detail coefficients at scale 2”, and are indicated as cD2. The resulting samples from the second digital low pass filter 122 are termed “approximation coefficients at scale 2”, and are indicated as cA2. Because of the downsampling, the detail coefficients at scale 2 (cD2) represent a lower frequency interval than the detail coefficients at scale 1 (cD1).

In a similar manner, the analyser 100 comprises a series of stages, each n-th stage comprising an n-th digital high-pass filter and an n-th digital low-pass filter receiving the approximation coefficients at scale (n-1) and providing detail coefficients at scale n and approximation coefficients at scale n, respectively.

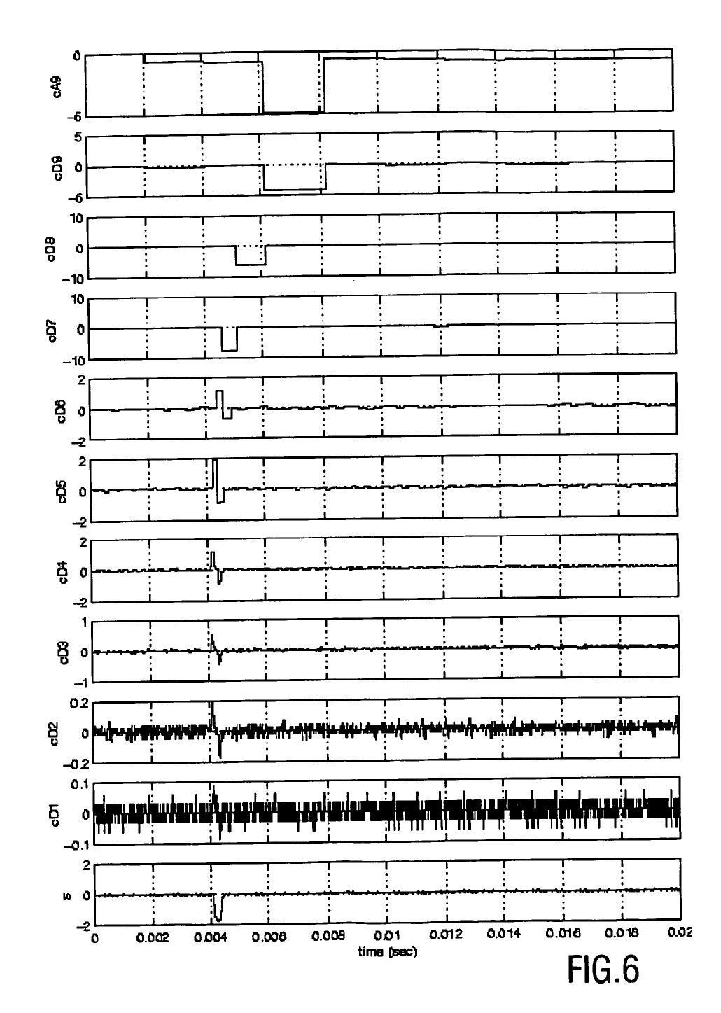

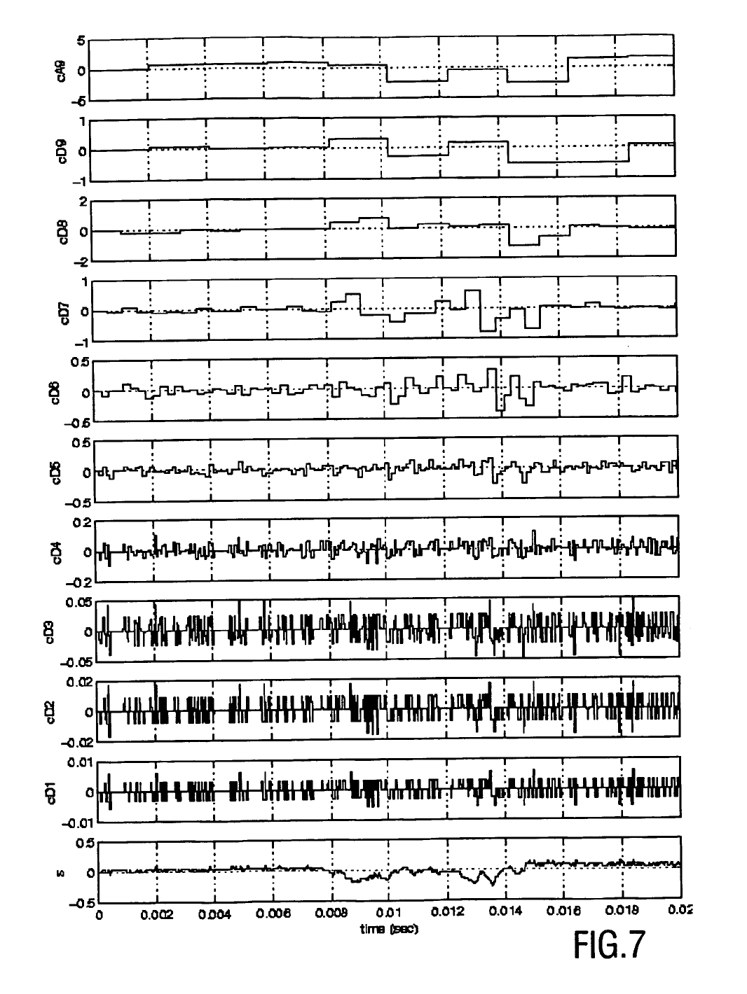

FIGS. 5-7 illustrate the result of discrete wavelet analysis, applied to measured signals from an optical disc drive. An optical disc was prepared, containing a black dot and a fingerprint. The disc was played, and the resulting MIRN signal, which indicates the amount of reflected light, was measured. FIG. 5 is a graph showing the result of these measurements. The horizontal axis represents time, while the vertical axis represents signal strength. Curve 61 shows the MIRN signal for the case of the black dot, while the lower curve 62 shows the MIRN signal for the case of the fingerprint. Both curves 61 and 62 show that the corresponding disc defects both cause a drop in the amount of reflected light, but the character of the signals 61 and 62 is clearly very different. This difference in signal character is also clearly observed in the result of the wavelet decomposition, as illustrated in FIGS. 6 and 7.

FIG. 6 is a collection of graphs, showing the MIRN signal to be analysed (bottom graph) and the detail coefficients at scale 1 to 10 (in rising order), for the case of the black dot. The sharp peak in the signal (see also curve 61 in FIG. 5) causes an effect at all scales, but the best (fastest) detection of the defect is obtained at scale 2 or 3 (cD2 or cD3, respectively). It is noted that scratches give comparable results.

FIG. 7 is a comparable collection of graphs, now for the case of the fingerprint. It is clearly visible that at scale 2 or 3, where the black dot can be detected well, the fingerprint has no frequency content. However, the effect of the fingerprint is clearly visible at scale 6, 7 and 8.

Thus, using discrete wavelet analysis, the analyser 72 is capable of classifying different defects and, on the basis of the analysis, to generate an appropriate control signal S_{CS} such that the controller (81, 82, 83; 80) for the actuator 51 has an appropriate setting.

In a possible implementation, the analyser 72 operates as follows. Initially, the analyser generates its control signal S_{CS} to select a normal setting for the control operation (controller 81, or setting 86). The detail outputs of certain scales are monitored, as well as the signal level of the original input signal MIRN.

If the detail output of scales 2 or 3, or both, provides a large signal above a predetermined threshold level, the signal level of the original input signal MIRN is captured and stored as a reference value, and the analyser 72 generates its control signal S_{CS} to select a setting specially adapted to short disc defects (controller 82, or setting 87). If the detail output of said scales 2 or 3 drops below said threshold again, and the original input signal MIRN has risen above the captured reference value, the analyser output signal is switched back to normal setting.

If the detail output of scales 6 or 7 or 8, or both, provides a large signal above a predetermined threshold level, while the detail outputs of lower scales do not provide a large signal, the signal level of the original input signal MIRN is captured and stored as a reference value, and the analyser 72 generates its control signal S_{CS} to select a setting specially adapted to long disc defects (controller 83, or setting 88). If the detail output of said scales 6 or 7 or 8 drops below said threshold again, and the original input signal MIRN has risen above the captured reference value, the analyser output signal is switched back to normal setting.

It should be clear to a person skilled in the art that the present invention is not limited to the exemplary embodiments discussed above, but that several variations and modifications are possible within the protective scope of the invention as defined in the appending claims.

In the above, the time-frequency analysis has been explained by discussing standard wavelet decomposition with reference to FIGS. 6-7. Alternatively, it is possible to feed the output signals from the high-pass filters (cDn) to a stage with high-pass and low-pass filters for further analysis. This method is called “wavelet packet analysis”. It provides a way to subdivide frequency bands.

In the above, the mirror signal MIRN has been discussed as an example of a signal suitable for frequency content analysis. As an alternative, other signals may be used for analysis, such as an error signal, or a controller output signal, for example.

In the above, the present invention has been explained with reference to an embodiment with a six-segment optical detector. It should be clear to a person skilled in the art that detectors having different design are also possible, in which case the formulas for error signals may be different.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Optical disc drive apparatus (1) for reading or writing optical discs (2), comprising:
an optical system (30) for scanning a track of an optical disc, the optical system (30) comprising at least one displaceable element (34) and at least one detector (35) for receiving an optical beam (32d) and generating a read signal (S_{R});
an actuator system (50) comprising at least one controllable actuator (51, 52, 53) for positioning said displaceable element (34);
a control system (90) for receiving and processing said read signal (S_{R}) from said detector (35) and for generating a control signal (S_{CR}, S_{CF}, S_{CT}) for said at least one controllable actuator (51, 52, 53) on the basis of at least one error signal component (REN, FEN) of said read signal (S_{R});
the control system (90) having variable settings;
the control system (90) being designed to perform a frequency analysis of at least one control signal component (MIRN) of said read signal (S_{R}), and to set its settings on the basis of the results of said frequency analysis.

2. Optical disc drive apparatus according to claim 1, wherein said at least one control signal component (MIRN) of said read signal (S_{R}) for frequency analysis is the normalized mirror signal (MIRN).

3. Optical disc drive apparatus according to claim 1, wherein the control system (90) is designed to detect and classify disc defects on the basis of the results of said frequency analysis, and to set its settings on the basis of the classification of a detected defect.

4. Optical disc drive apparatus according to claim 3, wherein the control system (90) is designed to set:
a first setting in the case of normal operation;
a second setting different from said first setting if it detects a short disc defect such as a black dot or a scratch;
a third setting different from any of said first and second settings if it detects a long disc defect such as a fingerprint.

5. Optical disc drive apparatus according to claim 1, wherein the frequency analysis performed by said control system (90) is a time-frequency analysis.

6. Optical disc drive apparatus according to claim 5, wherein the time-frequency analysis performed by said control system (90) is a discrete wavelet analysis.

7. Optical disc drive apparatus according to claim 6, wherein the control system (90) is designed to select a setting for short defects if a detail coefficient at scale 2 or 3 (cD2 or cD3) has a signal level above a predetermined threshold level.

8. Optical disc drive apparatus according to claim 7, wherein the control system (90) is designed, at the moment when the signal level of said detail coefficient at scale 2 or 3 (cD2 or cD3) rises above said predetermined threshold level, to capture the signal level of the said at least one signal component (MIRN) of said read signal (S_{R}) which is being time-frequency analysed, and to switch back to a setting for normal operation if the signal level of said detail coefficient at scale 2 or 3 (cD2 or cD3) has dropped below said predetermined threshold level and the signal level of the said at least one signal component (MIRN) of said read signal (S_{R}) which is being time-frequency analysed has risen above said captured signal level.

9. Optical disc drive apparatus according to claim 7, wherein the control system (90) is designed to select a setting for long defects if a detail coefficient at scale 6 or 7 or 8 (cD6 or cD7 or cD8) has a signal level above a predetermined threshold level while all detail coefficients at lower scales have signal levels below predetermined threshold levels.

10. Optical disc drive apparatus according to claim 1, wherein the control system (90) comprises:
a signal processor (71) for processing the read signal (S_{R}) from the detector (35) and for generating said error signal components (REN, FEN) and said control signal component (MIRN);
a plurality of controllers (81, 82, 83), which each have an input receiving an error signal component (REN), each controller being designed to generate an actuator control signal (S_{CR1}, S_{CR2}, S_{CR3}), respectively, and each controller having optimized settings for use in specific situations;
a controllable switch (73) having a plurality of inputs (73a, 73b, 73c) coupled to the respective outputs of said controllers (81, 82, 83), and having an output (73d) coupled to an output (93) of the control circuit (90), the switch being designed to selectively couple its output (73d) to one of its inputs (73a, 73b, 73c) on the basis of a control signal (S_{CS}); and a signal analyser (72) having an input receiving a control output signal (MIRN) from the signal processor (71), and having an output for generating said control signal (S_{CS}) for controlling said controllable switch (73).

11. Optical disc drive apparatus according to claim 1, wherein the control system (90) comprises:
a signal processor (71) for processing the read signal (S_{R}) from the detector (35) and for generating said signal components (REN, FEN) and said control signal component (MIRN);
a controller (80), having an input receiving an error signal component (REN) and having an output coupled to an output (93) of the control circuit (90), said controller being designed to generate an actuator control signal (S_{CR}), said controller having a plurality of optimized settings (86, 87, 88) for use in specific situations;
a controllable switch (73) having an output coupled to said controller (80), for selectively setting one of the controller settings (86, 87, 88) on the basis of a control signal (S_{CS});
and a signal analyser (72) having an input receiving a control output signal (MIRN) from the signal processor (71), and having an output for generating said control signal (S_{CS}) for controlling said controllable switch (73).

12. Method for discriminating different types of disc defects in an optical disc drive apparatus (1), the disc drive apparatus (1) comprising:
scanning means (30) for scanning a record track of an optical disc (2) and for generating a read signal (S_{R}), the scanning means (30) comprising at least one displaceable read/write element (34);
actuator means (50) for controlling the positioning of said at least one read/write element (34) with respect to the disc (2);
a control circuit (90) for receiving said read signal (S_{R}) and generating at least one actuator control signal (S_{CR}, S_{CF}, S_{CT}) on the basis of at least one error signal component (REN, FEN) of said read signal (S_{R}), the control circuit (90) having a plurality of predetermined controller settings;
the method comprising the steps of:
deriving from said read signal (S_{R}) at least one control signal component (MIRN);
performing a frequency analysis of said at least one control signal component (MIRN);
selectively setting one of said plurality of predetermined controller settings on the basis of the results of said frequency analysis.
